(19) United States
(12) Patent Application Publication
(10) Pub. No.: US 2007/0171771 A1
(43) Pub. Date: Jul. 26, 2007

(54) Picture-convertible clock/watch dial

(76) Inventor: Ming-Te Pan, Pan-Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/336,768

(22) Filed: Jan. 23, 2006

(51) Int. Cl. G04B 19/00

(52) U.S. Cl. 368/223

(57) ABSTRACT

A picture-convertible clock/watch dial including: a picture layer overlaid on a dial area of a clock/watch, the picture layer being formed with multiple picture zones, multiple pixels being drafted on each picture zone to form a complete picture; a display board overlaid on outer face of the picture layer, one face of the display board being formed with multiple refractive sections arranged in parallel to each other; and a driving unit for reciprocally displacing the picture layer. When a picture zone is moved to a position where the pixels of the picture zone are aligned with the refractive sections of the display board, the pixels are refracted and magnified to show a complete picture on the display board. At this time, the other pixels of the other picture zones are not aligned with the refractive sections and are thus minified and visually hidden.

### BACKGROUND OF THE INVENTION

1. Field of the Invention

The present invention is related to a picture-convertible clock/watch dial in which the pictures of the clock/watch can be repeatedly changed.

2. Description of the Prior Art

A common clock or watch has a dial generally having monotonous color. Such dial lacks attraction to consumers.

Some manufactures of clocks or watches print colorful pictures on the dial to beautify the appearance of the dial and thus enhance the attraction to the consumers. However, such picture is also monotonous and unchangeable. After a period of use, a user will lose his/her attention to the clock or watch. Therefore, it is tried by the applicant to provide a picture-convertible clock/watch dial in which the pictures of the clock/watch can be repeatedly changed to enhance the attraction of the clock/watch to the consumers and add more fun in use of the clock/watch.

### SUMMARY OF THE INVENTION

It is therefore a primary object of the present invention to provide a picture-convertible clock/watch dial including: a picture layer overlaid on a dial area of a clock/watch, the picture layer being formed with multiple picture zones, each picture zone being composed of multiple stripe zones arranged in parallel to each other at equal intervals, the stripe zones of different picture zones being interlaced with each other, a pixel of a complete picture being drafted in each stripe zone; a display board overlaid on outer face of the picture layer, a first face of the display board being formed with multiple refractive sections arranged in parallel to each other; and a driving unit for reciprocally displacing the picture layer, when the stripe zones of a first picture zone are moved to a position where the stripe zones are aligned with the refractive sections of the display board, the pixels of the stripe zones being refracted and magnified to show a complete first picture on the display board, while the other pixels of the stripe zones of a second picture zone being not aligned with the refractive sections and thus refracted, minified and visually hidden, whereby the pictures of the clock/watch dial are convertible.

The present invention can be best understood through the following description and accompanying drawings wherein:

### BRIEF DESCRIPTION OF THE DRAWINGS

FIG. 1 is a perspective exploded view of the present invention;

FIG. 2 is a front view of the picture layer of the present invention, showing the distribution of the pixels of the picture layer;

FIG. 3 shows that the picture of the first picture zone of the picture layer is shown;

FIG. 4 shows that the pixels of the first picture zone of the picture layer are aligned with the refractive sections of the display board to show the picture of the first picture zone;

FIG. 5 shows that the picture of the second picture zone of the picture layer is shown;

FIG. 6 shows that the pixels of the second picture zone of the picture layer are aligned with the refractive sections of the display board to show the picture of the second picture zone;

FIG. 7 is a front view of the present invention, in which a first picture is shown;

FIG. 8 is a perspective view according to FIG. 7;

FIG. 9 is a front view of the present invention, in which a second picture is shown;

FIG. 10 is a perspective view according to FIG. 9; and

FIG. 11 is a schematic diagram showing the driving unit of the present invention.

### DETAILED DESCRIPTION OF THE PREFERRED EMBODIMENTS

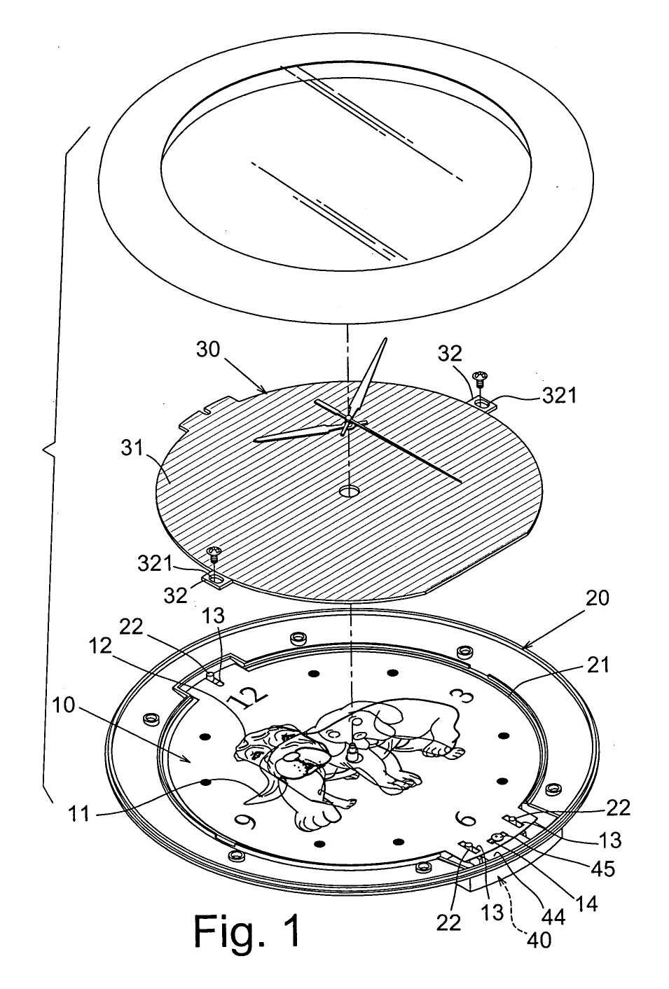

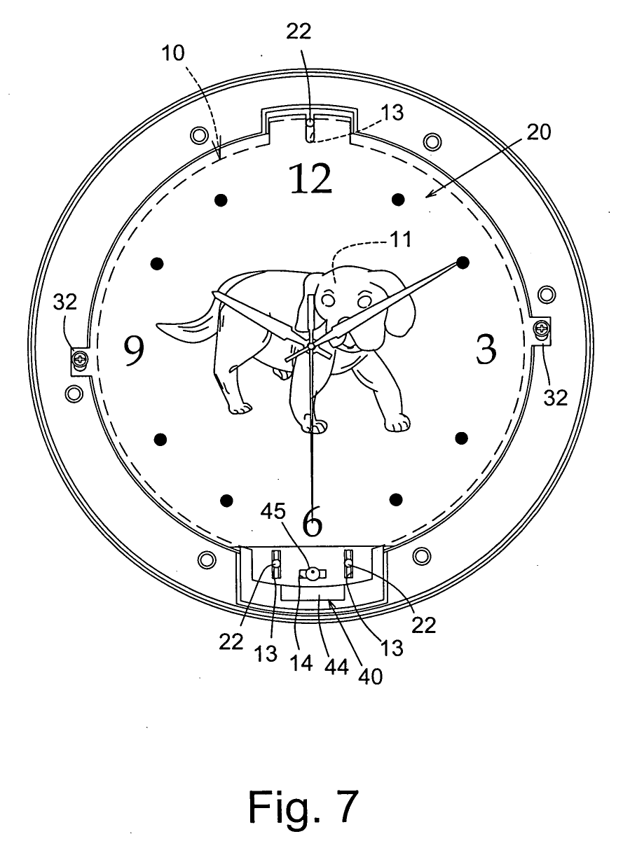

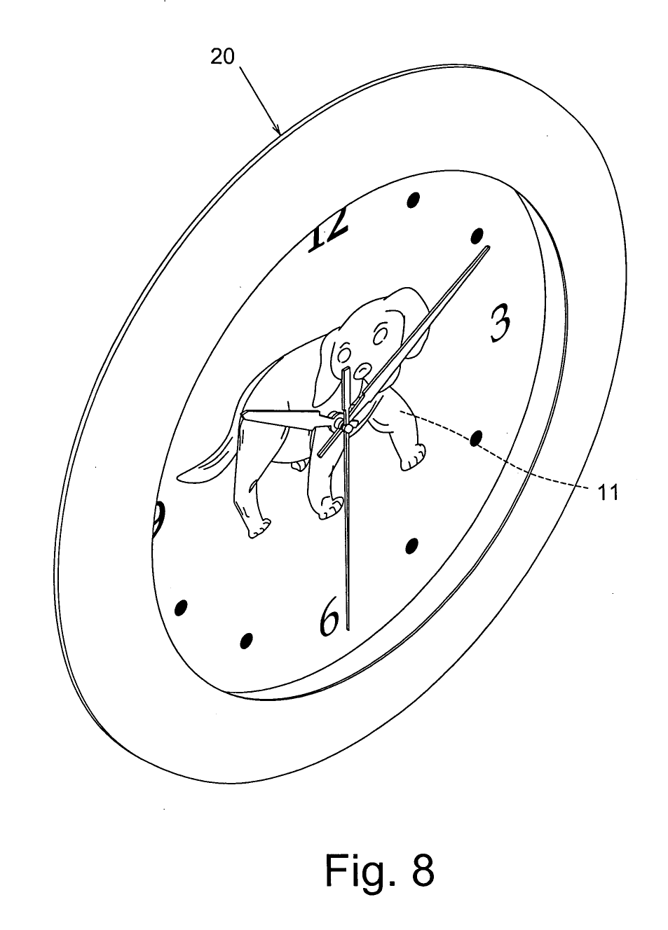

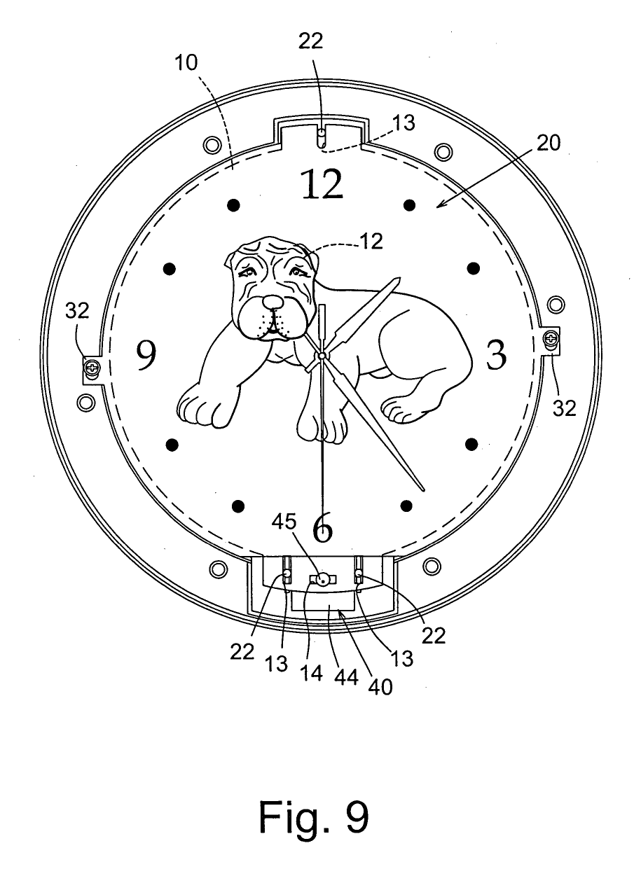

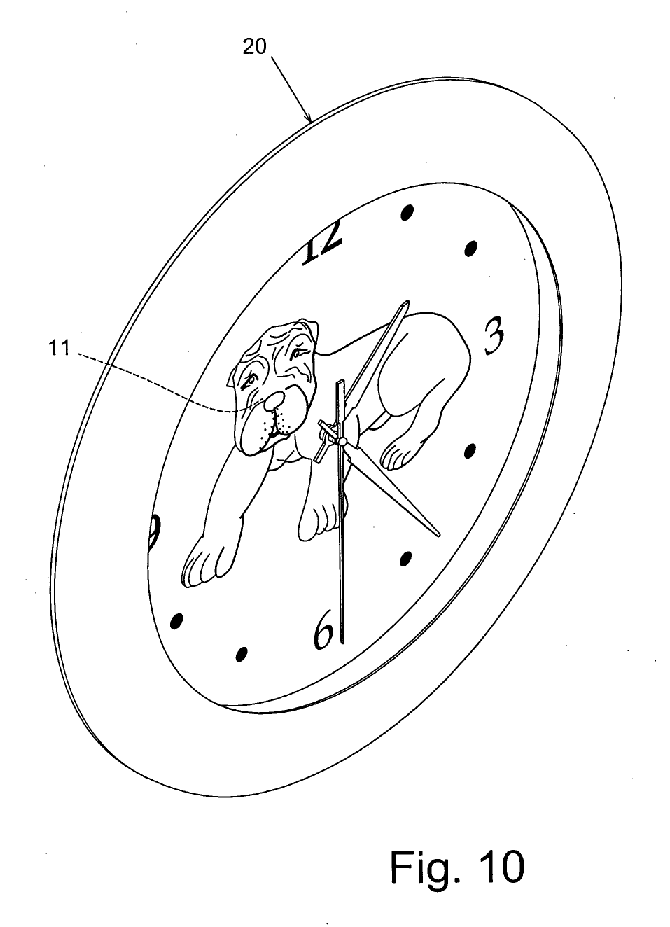

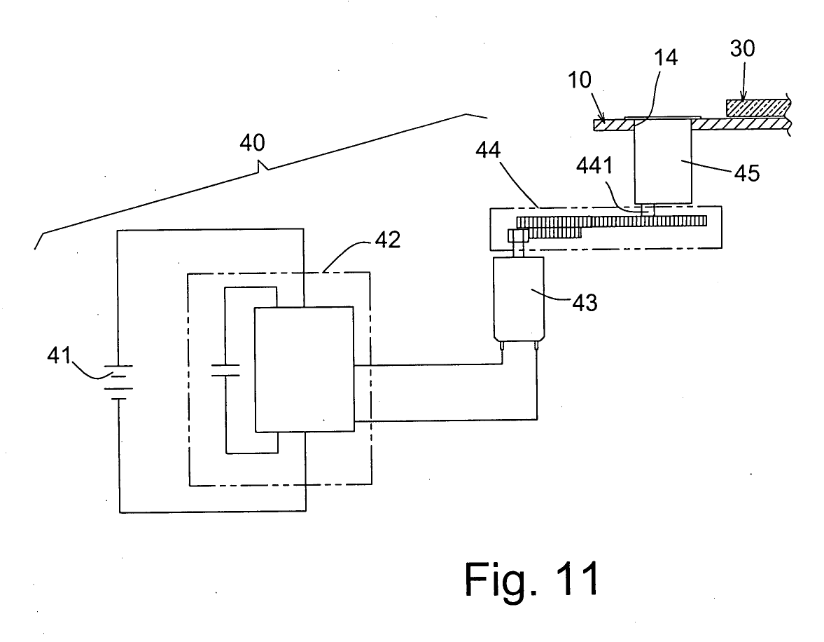

Please refer to FIGS. 1 to 11. The picture-convertible clock/watch dial of the present invention includes a picture layer 10 overlaid on a dial area 21 of a clock/watch 20. The picture layer 10 is formed with multiple picture zones 11, 12. Each picture zone 11, 12 is composed of multiple stripe zones 111, 121 arranged in parallel to each other at equal intervals. The stripe zones 111 and 121 of different picture zones 11, 12 are interlaced with each other. A pixel 110, 120 of a complete picture is drafted in each stripe zone 111, 121. The picture-convertible clock/watch dial of the present invention further includes a display board 30 overlaid on outer face of the picture layer 10. A first face of the display board 30 is formed with multiple refractive sections 31 arranged in parallel to each other. The picture-convertible clock/watch dial of the present invention further includes a driving unit 40 for reciprocally displacing the picture layer 10. When the stripe zones 111 or 121 of the picture zone 11 or 12 are moved to a position where the stripe zones 111 or 121 are aligned with the refractive sections 31 of the display board 30, the pixels 110 or 120 of the stripe zones 111 or 121 will be refracted and magnified to show a complete picture on the display board 30. At this time, the other pixels 120 or 110 of the stripe zones 121 or 111 of the picture zone 12 or 11 are not aligned with the refractive sections 31 and thus are refracted and minified as the pixels 120 or 110 are visually hidden. Accordingly, the pictures of the clock/watch dial are convertible.

Each refractive section 31 of the display board 30 can have an arced or triangular cross-section. The profile of the refractive section 31 is not limited.

Referring to FIGS. 1, 7 and 9, in the picture-convertible clock/watch dial of the present invention, the outer circumference of the picture layer 10 is formed with multiple guide slots 13. Multiple guide pins 22 are fixed on the casing of the clock/watch 20. The guide pins 22 are inlaid in the guide slots 13, whereby the picture layer 10 can linearly slide along the guide pins 22.

In the picture-convertible clock/watch dial of the present invention, the display board 30 is made of transparent material such as transparent plastic board or glass. The material of the display board 30 is not limited. The outer circumference of the display board 30 is formed with lugs 32 each having a through hole 321. Screws are passed through the through holes 321 to lock the display board 30 on the casing of the clock/watch 20.

Referring to FIGS. 1, 7, 9 and 11, the driving unit 40 of the picture-convertible clock/watch dial of the present invention includes a cell power supply 41, a stabilizing circuit 42 connected with the power supply 41, a driving motor 43 drivable by the power supply 43 and a transmission case 44 in which a gear system is mounted. A cam 45 is eccentrically fitted on an output shaft 441 of the transmission case 44. The cam 45 is snugly fitted in a driven guide slot 14 of the picture layer 10. The driving motor 43 serves to drive the gear system to rotate the cam 45, whereby the picture layer 10 is linearly reciprocally displaced.

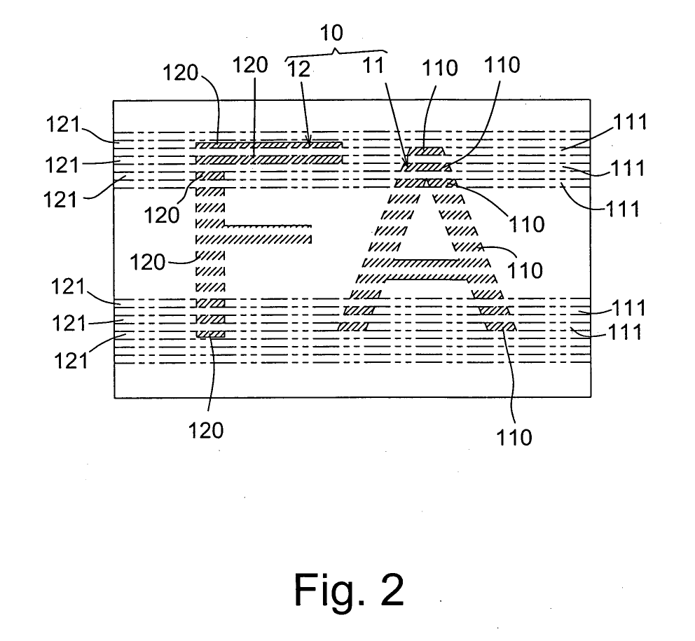

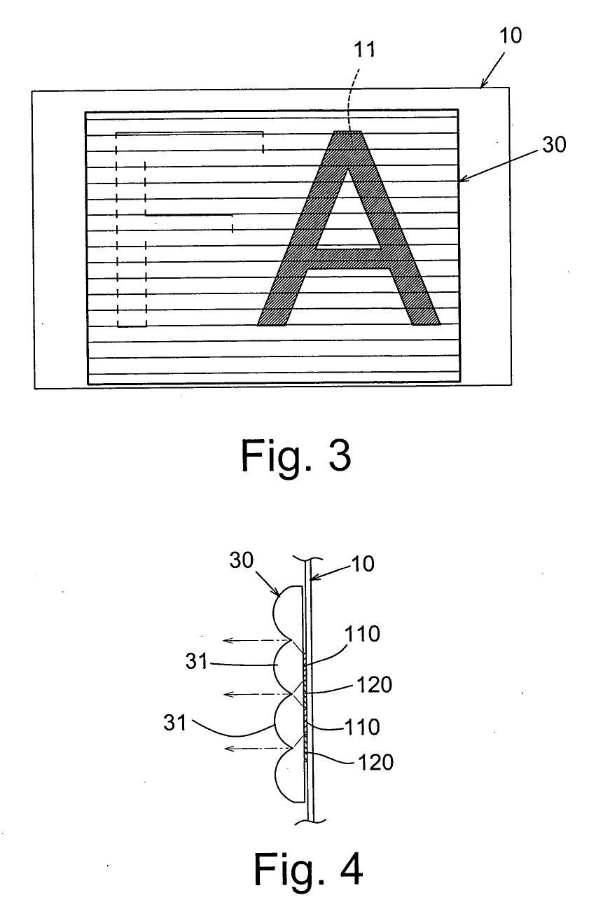

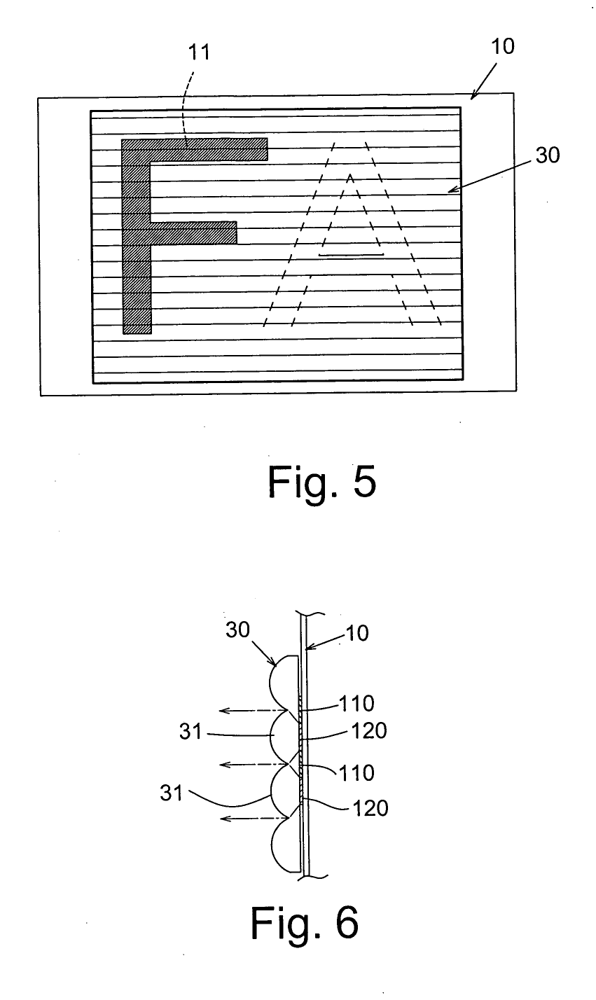

Referring to FIGS. 2 to 6, the picture-convertible clock/watch dial of the present invention is operated in such a manner that the pixels 110 of the first picture zone 11 forming “A” as shown in FIG. 2 are distributed and respectively positioned in the first set of stripe zones 111. The pixels 120 of the second picture zone 12 forming “F” are distributed and respectively positioned in the second set of stripe zones 121. Accordingly, the pixels 110 forming “A” are parallel to the pixels 120 forming “F” but not aligned therewith. Therefore, when the picture layer 10 is driven by the driving unit 40 to reciprocally move relative to the display board 30, the pixels 110 or 120 aligned with the refractive sections 31 of the display board 30 are magnified and displayed. Reversely, the other pixels 120 or 110 not aligned with the refractive sections 31 are minified and hidden. Referring to FIGS. 3, 4 and 11, when the driving unit 40 drives the picture layer 10 to make the pixels 110 of the first picture zone 11 aligned with the refractive sections 31 of the display board 30, the refractive sections 31 will magnify the pixels 110 due to refraction. At this time, the picture “A ” formed of the pixels 110 will be shown on the display board 30 as shown in FIG. 3. At this time, the pixels 120 of the second picture zone 12 are minified and hidden or become unapparent due to refraction. As shown in FIGS. 5, 6 and 11, when the driving unit 40 drives the picture layer 10 to make the pixels 120 of the second picture zone 12 aligned with the refractive sections 31 of the display board 30, the refractive sections 31 will magnify the pixels 120 due to refraction. At this time, the picture “F” formed of the pixels 120 will be shown on the display board 30 as shown in FIG. 5. At this time, the pixels 110 of the first picture zone 11 are minified and hidden or become unapparent due to refraction. Accordingly, by means of reciprocally moving the picture layer 10, the pictures on the display board 30 are convertible.

The picture zones 11, 12 of the picture layer 10 can be characters or pictures of animals, landscapes, portraits, etc. This is not limited.

According to the above arrangement, by means of reciprocally moving the picture layer 10 of the clock/watch 20, the pictures on the display board 30 can be repeatedly changed. Therefore, the dial of the clock/watch 20 is no more monotonous and becomes funnier.

The above embodiments are only used to illustrate the present invention, not intended to limit the scope thereof. Many modifications of the above embodiments can be made without departing from the spirit of the present invention.

What is claimed is:

1. A picture-convertible clock/watch dial comprising:
a picture layer overlaid on a dial area of a clock/watch, the picture layer being formed with multiple picture zones, each picture zone being composed of multiple stripe zones arranged in parallel to each other at equal intervals, the stripe zones of different picture zones being interlaced with each other, a pixel of a complete picture being drafted in each stripe zone;
a display board overlaid on outer face of the picture layer, a first face of the display board being formed with multiple refractive sections arranged in parallel to each other; and
a driving unit for reciprocally displacing the picture layer, when the stripe zones of a first picture zone are moved to a position where the stripe zones are aligned with the refractive sections of the display board, the pixels of the stripe zones being refracted and magnified to show a complete first picture on the display board, while the other pixels of the stripe zones of a second picture zone being not aligned with the refractive sections and thus refracted, minified and visually hidden, whereby the pictures of the clock/watch dial are convertible.

2. The picture-convertible clock/watch dial as claimed in claim 1, wherein an outer circumference of the picture layer is formed with multiple guide slots and multiple guide pins are fixed on a casing of the clock/watch, the guide pins being inlaid in the guide slots, whereby the picture layer can linearly slide along the guide pins.

3. The picture-convertible clock/watch dial as claimed in claim 1, wherein an outer circumference of the display board is formed with lugs each having a through hole, screws being passed through the through holes to lock the display board on a casing of the clock/watch.

4. The picture-convertible clock/watch dial as claimed in claim 1, wherein the driving unit includes a cell power supply, a stabilizing circuit connected with the power supply, a driving motor drivable by the power supply and a transmission case in which a gear system is mounted, a cam being eccentrically fitted on an output shaft of the transmission case, the cam being snugly fitted in a driven guide slot of the picture layer, the driving motor serving to drive the gear system to rotate the cam, whereby the picture layer is linearly reciprocally displaceable.
